(19) United States
(12) Patent Application Publication
(10) Pub. No.: US 2010/0251283 A1
(43) Pub. Date: Sep. 30, 2010

(54) SYSTEM AND MEHOD FOR PROVIDING INTERACTIVE CONTENT

(75) Inventor: Allen W. Smith, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/414,955

(22) Filed: Mar. 31, 2009

(51) Int. Cl. H04N 7/16; G06F 13/00; G10L 21/00; H04N 7/173

(52) U.S. Cl. 725/25; 725/61; 704/275; 725/131; 704/E21.001

(57) ABSTRACT

A system and method for providing interactive content are disclosed. In one embodiment, the method comprises receiving, in a vehicle via a wireless broadcast, audiovisual content and user-requestable content, rendering the audiovisual content, receiving user input indicative of request for the user-requestable content, and rendering, in response to receiving the user input, the user-requestable content. The user-requestable content can include, but is not limited to, additional audiovisual content, climate control data, and navigation data.

### BACKGROUND

Electronic devices, including vehicular entertainment systems, may be configured to receive broadcasts of sports, entertainment, informational programs, advertisements, or other multimedia content items. For example, audio and/or video data may be communicated using a broadband broadcast communications link to the electronic devices. There is a need to provide a person an enhanced viewing experience on such devices.

### SUMMARY

The system, method, and devices of the invention each have several aspects, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Embodiments” one will understand how the features of this invention provide advantages that include a user experience enhanced by interactive content.

One aspect of the invention comprises a method of providing interactive content to a user, the method comprising receiving, in a vehicle via a wireless broadcast, audiovisual content and user-requestable content, rendering the audiovisual content, receiving user input indicative of request for the user-requestable content, and rendering, in response to receiving the user input, the user-requestable content.

Another aspect of the invention comprises a system for providing interactive content to a user, the system comprising a receiver configured to receive, via a wireless broadcast, audiovisual content and user-requestable content, an input device configured to receive a user input indicative of request for the user-requestable content, and a vehicular entertainment system configured to render the audiovisual content and to render, in response to receiving the user input, the user-requestable content.

Yet another aspect of the invention comprises a system for providing interactive content to a user, the system comprising means for receiving audiovisual content and user-requestable content, means for rendering the audiovisual content, means for receiving user input indicative of request for the user-requestable content, and means for rendering, in response to receiving the user input, the user-requestable content.

### BRIEF DESCRIPTION OF THE DRAWINGS

FIG. 1 is a cut-away diagram of a vehicle.

FIG. 2 is a functional block diagram of a vehicular electronic system.

FIG. 3 is a block diagram illustrating an exemplary system for providing broadcast programming.

FIG. 4 is a flowchart illustrating a method of providing interactive content.

FIG. 5 is a flowchart illustrating a method of providing interactive content based on a voice prompt.

FIG. 6 is a diagram illustrating an exemplary data structure for receiving or storing interactive content.

FIG. 7 is a flowchart illustrating a method of providing interactive content based on a vehicular state.

FIG. 8A is a diagram of exemplary audiovisual content rendered on a rear display.

FIG. 8B is a diagram of exemplary audiovisual content rendered on a front display.

### DETAILED DESCRIPTION OF THE PREFERRED EMBODIMENT

The following detailed description is directed to certain specific aspects of the invention. However, the invention can be embodied in a multitude of different ways, for example, as defined and covered by the claims. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

A vehicular entertainment system (VES) generally allows the driver and/or passengers of a motor vehicle to experience audio and/or video from the comfort of the vehicle. The first vehicular entertainment systems were simply AM/FM radios connected to a number of speakers. As technology progressed, more sophisticated vehicular entertainment systems developed, included those with the ability to play cassette tapes, CDs, and DVDs. Vehicular entertainment systems may also include mobile receivers configured to receive broadcasts of sports, entertainment, informational programs, advertisements, or other multimedia content items. For example, audio and/or video data may be communicated using a conventional AM radio broadcast, an FM radio broadcast, a digital radio broadcast, a satellite radio broadcast, a conventional television broadcast, or a high definition television broadcast. Audiovisual data can also be received via a broadband broadcast communications link to a VES or component thereof.

As part of the vehicular electronics, vehicular entertainment systems are generally linked to other vehicular components, such as a climate control system, a vehicular navigation system, a transmission, or a speedometer, and can take advantage of this connection to further enhance the multimedia experience of rendered content by supplementing the audio or visual content with data to the components, or by basing the audio or visual content on information from the components.

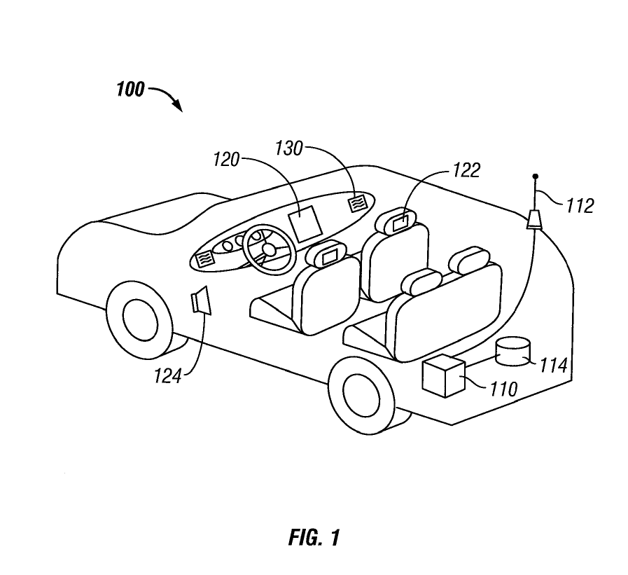

FIG. 1 is a cut-away diagram of a vehicle 100. The vehicle 100 includes a vehicular entertainment system processor 110 configured to receive and process multimedia content. The multimedia content can include audio data and video data. The VES processor 110 can receive data from a number of sources, including via an antenna 112 or a computer-readable storage 114. For example, the VES processor 110 can receive, via the antenna 112, an AM or FM radio broadcast, a digital radio broadcast, a satellite radio broadcast, a television broadcast, a high definition television broadcast, or a broadband digital multimedia broadcast (also known as “mobile TV”), such as a MediaFLO™ broadcast. As a further example, the VES processor 110 can also receive, via the computer-readable storage 114, multimedia data from a cassette tape player, a CD player, a DVD player, MP3 player, or a flash drive.

The VES processor 110 can receive the multimedia data and perform processing on the data for rendering via a vehicle entertainment system. For example, the VES processor can receive video data and process it for rendering on a front console display 120 or one or more rear displays 122. As another example, the VES processor 110 may receive a FM broadcast via the antenna 112, and demodulate the signal for rendering over one or more speakers 124. The VES processor 110 can further receive and submit commands to various vehicular components for rendering of additional data. For example, the VES processor 110 can receive and submit commands to the climate control system 130 to alter the temperature of the vehicle. As another example, the VES processor 110 can receive and submit commands to the navigation system to display a particular location or provide instructions to reach the location. The VES processor 110 can further receive data from other vehicular components and base the rendering of audiovisual content on the received data. For example, the VES processor 110 can receive data from the navigation system indicating that a user is located in a particular city and render an advertisement particular to that city. As another example, the VES processor 110 can receive data from the transmission indicating that the vehicle is parked, or from the speedometer indicating that the vehicle is under a speed threshold, before rendering video data.

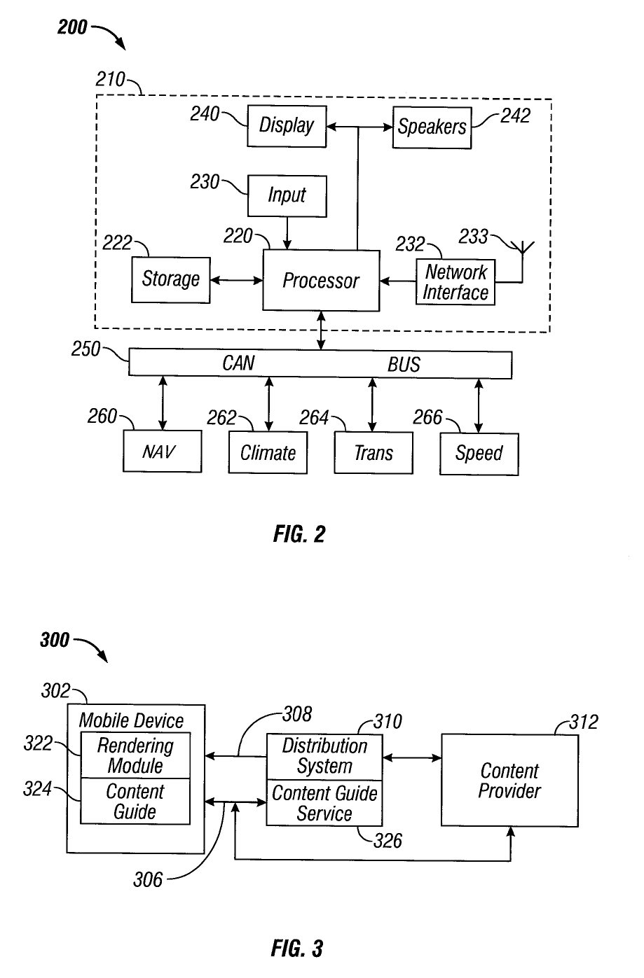

FIG. 2 is a functional block diagram of a vehicular electronic system. The vehicular electronics 200 includes a vehicular entertainment system 210 operatively coupled, via a bus 250 to the rest of the electronics. The VES 210 includes a processor 220, an input 230, a display 240 and speakers 242, storage 222, and an antenna 233 connected via an interface 232. Certain functionalities of the processor 220 have been described with respect to FIG. 1, including the receiving of multimedia data and processing of that data. The processor 220 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A general purpose processor may be a microprocessor such as an ARM, Pentium®, Pentium II®, Pentium III®, Pentium IV®, Pentium® Pro, an 8051, a MIPS®, a Power PC®, or an ALPHA®, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. For example, the processor can comprise a Qualcomm CDMA Technologies (QCT) chipset, such as from the Mobile Station Modem (MSM) chipset family.

The steps of a method or algorithm described in connection with the embodiments disclosed herein may be embodied directly in hardware, in a software module executed by a processor, or in a combination of the two. A software module may reside in any suitable computer-readable medium, such as the storage 222. The storage 222 can be a volatile or non-volatile memory such as a DRAM memory, flash memory, ROM memory, EPROM memory, EEPROM memory, registers, hard disk, a removable disk, a CD-ROM, or any other form of suitable storage medium known in the art. An exemplary storage medium is coupled to the processor such the processor can read information from, and write information to, the storage medium. In the alternative, the storage medium may be integral to the processor. The processor and the storage medium may reside in an ASIC or in any suitable commercially available chipset.

The VES processor 220 can be manipulated via an input 230. The input 230 can include, but is not limited to, a keyboard, buttons, keys, switches, a pointing device, a mouse, a joystick, a remote control, an infrared detector, a video camera (possibly coupled with video processing software to, e.g., detect hand gestures or facial gestures), a motion detector, or a microphone (possibly coupled to audio processing software to, e.g., detect voice commands). In another embodiment, the VES processor 220 receives input from an input device external to the VES 210, such as a voice control system of the vehicle. This input can be received via the bus 250. Video and audio data are output, respectively, via a display 240 and a speaker system 242. The display 240 can include, for example, a touch screen. The display 240 can include a screen in the front of the vehicle for viewing by the driver or front seat passenger. The display 210 can also include one or more screens affixed to the headrest or attached to the ceiling for viewing by a rear seat passenger.

The VES processor 220 can also receive data from an antenna 233 via a network interface 232. The network interface 232 may receive signals according to wireless technologies comprising one or more of a code division multiple access (CDMA or CDMA2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, a high data rate (1×EV-DO or 1×EV-DO Gold Multicast) system, an IEEE 802.11 system, a MediaFLO™ system, a DMB system, an orthogonal frequency division multiple access (OFDM) system, or a DVB-H system.

The VES processor 220 can be connected to one or more interfaces via a controller-area network (CAN bus) 250 or other vehicle bus. A vehicle bus is a specialized internal communications network that interconnects components inside a vehicle (e.g. automobile, bus, industrial or agricultural vehicle, ship, or aircraft). Special requirements for vehicle control such as assurance of message delivery, assured non-conflicting messages, assured minimum time of delivery as well as low cost, EMF noise resilience, redundant routing, and other characteristics encourage the use of specific networking protocols.

The CAN bus 250 interconnects the processor 220 with other vehicular subsystems, including the navigation system 260, the climate control system 262, the transmission 264, and the speedometer 266. Non-audiovisual metadata can be transmitted to one or more of the subsystems to render additional content. For example, the climate control system 262 can be made to blow cool or warm air from the vents or the navigation system 260 can be made to display a particular location or provide directions to the location.

In some embodiments, the system can receive digital broadcast programming, via, e.g., the antenna 233 and network interface 232 of FIG. 2. FIG. 3 is a block diagram illustrating an example system 300 for providing broadcast programming to mobile devices 302 from one or more content providers 312 via a distribution system 310. Although the system 300 is described generally, the mobile device 302 can, for example, be a component of a vehicular entertainment system, such as the VES processor 110 of FIG. 1. Although one mobile device 302 is shown in FIG. 3, examples of the system 300 can be configured to use any number of mobile devices 302. The distribution system 310 can receive data representing multimedia content items from the content provider 312. The multimedia content items can be communicated over a wired or wireless content item communication link 308. In the context of a vehicular entertainment system, the communication link 308 is generally a wireless radio frequency channel. In one embodiment, the communications link 308 is a high speed or broadband link. In one embodiment, the content provider 312 can communicate the content directly to the mobile device 302 (link not shown in FIG. 3), bypassing the distribution system 310, via the communications link 308, or via another link. It is to be recognized that, in other embodiments, multiple content providers 312 can provide content items via multiple distribution systems 310 to the mobile devices 302 either by way of the distribution system 310 or directly.

In the example system 300, the content item communication link 308 is illustrated as a broadcast or multicast unidirectional network to each of the vehicular entertainment system components 302. However, the content item communication link 308 can also be a fully symmetric bi-directional network.

In the example system 300, the mobile devices 302 are also configured to communicate over a second communication link 306. In one embodiment, the second communication link 306 is a two way communication link. In the example system 300, however, the link 306 can also comprise a second link from the mobile device 302 to the distribution system 310 and/or the content provider 312. The second communication link 306 can also be a wireless network configured to communicate voice traffic and/or data traffic. The mobile devices 302 can communicate with each other over the second communication link 306. Thus, the vehicular entertainment systems may be able to communicate vehicle-to-vehicle as part of the system. Alternatively, this may enable a mobile phone to communicate with the vehicular entertainment system. The communication link 306 can also communicate content guide items and other data between the distribution system 310 and the mobile devices 302.

The communication links 306 and 308 can comprise one or more wireless links, including one or more of a code division multiple access (CDMA or CDMA2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, a high data rate (1×EV-DO or 1×EV-DO Gold Multicast) system, an IEEE 802.11 system, a MediaFLO™ system, a DMB system, an orthogonal frequency division multiple access (OFDM) system, or a DVB-H system.

In addition to communicating content to the mobile device 302, the distribution system 310 can also include a program guide service 326. The program guide service 326 receives programming schedule and content related data from the content provider 312 and/or other sources and communicates data defining an electronic programming guide (EPG) 324 to the mobile device 302. The EPG 324 can include data related to the broadcast schedule of multiple broadcasts of particular content items available to be received over the program communication link 308. The EPG data can include titles of content items, start and end times of particular broadcasts, category classification of programs (e.g., sports, movies, comedy, etc.), quality ratings, adult content ratings, etc. The EPG 324 can be communicated to the mobile device 302 over the program communication link 308 and stored on the mobile device 302. For example, the EPG 324 can be stored in storage 222 of FIG. 2.

The mobile device 302 can also include a rendering module 322 configured to render the multimedia content items received over the content item communication link 308. The rendering module 322 can include analog and/or digital technologies. The rendering module 322 can include one or more multimedia signal processing systems, such as video encoders/decoders, using encoding/decoding methods based on international standards such as MPEG-x and H.26x standards. Such encoding/decoding methods generally are directed towards compressing the multimedia data for transmission and/or storage. The rendering module 322 can be a component of the processor 220 or FIG. 2 of the VES processor 110 of FIG. 1.

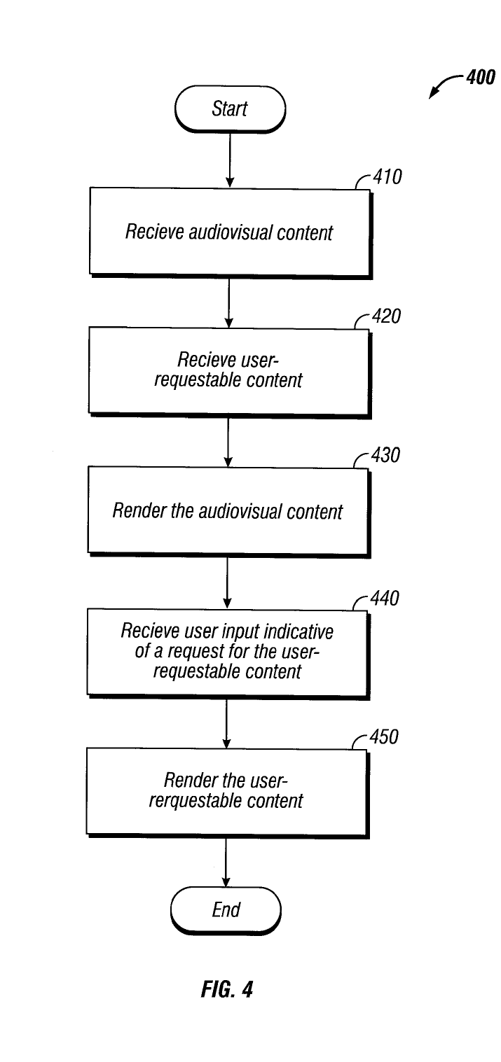

FIG. 4 is a flowchart illustrating a method 400 of providing interactive content. The method 400 begins, in block 410 with the system, such as the vehicle 100 of FIG. 1 or the VES 210 of FIG. 2, receiving audiovisual content. As an example of receiving audiovisual content, the VES processor 110 of FIG. 1 can receive an AM, FM, DVB-H, DMB, mobile TV, or MediaFLO™ broadcast via the antenna 112. The audiovisual content can include audio data, video data, or both. Continuing to block 420, the system receives user-requestable content associated with a subset of the audiovisual content. In general, a subset may include only one element of the set, at least two elements of the set, at least three elements of the set, a significant portion (e.g. at least 10%, 20%, 30%) of the elements of the set, a majority of the elements of the set, nearly all (e.g., at least 80%, 90%, 95%) of the elements of the set, all but two, all but one, or all of the elements of the set. The user-requestable content can be associated with a specific time or provided prompt of the audiovisual content. For example, the user-requestable content may be associated with a time interval of the audiovisual content after a spokesperson has stated “Would you like to hear more?”

For example, the audiovisual data may include time stamps indicating when particular portions of the audio or video data should be rendered. The user-requestable content can be associated with these time stamps to facilitate rendering the user-requestable content with, or immediately after, the audiovisual content with which it is associated.

Although blocks 410 and 420 are shown and described subsequently, in some embodiments, the audiovisual content and user-requestable content are received concurrently, in the same broadcast, or as parts of the same data file.

Next, in block 430, the system renders the audiovisual content. For example, the system can play audio content via the speakers 242 of FIG. 2. As another example, the system can display video content on the display 240 of FIG. 2. Continuing to block 440, the system receives user input indicative of a request for the user-requestable content. The user input can be received from the input 230 of FIG. 2, via a touch screen display 240, or via an input external to the VES 210 such as a voice control system of the vehicle. The user input can include pressing a key on a remote control, touching a region of a touch screen display, or saying “yes” to a particular prompt asking if the user would like to request additional content.

In response to receiving the user input in block 440, the process 400 moves to block 450 where the system renders the user-requestable content. The user-requestable content can include additional audiovisual content. Thus, rendering the user-requestable content can be performed as described above with respect to rendering the audiovisual content in block 430. The user-requestable content can, alternatively or additionally, include navigation data. Thus, rendering the user-requestable content can be performed by submitting commands to a navigation system to display a particular location or provide directions to a particular location. The user-requestable content can also include climate control data (or other environmental metadata). Thus, rendering the user-requestable content can be performed by submitting commands to a climate system to produce warm or cool air from vents. The user-requestable content can also include channel preset data. Thus, rendering the user-requestable content can be performed by the vehicular entertainment system by changing a radio channel preset to a particular channel.

Rendering of user-requestable content can be conditioned upon preprogrammed criteria. For example, rendering of user-requestable content can be conditioned upon user preferences. In one embodiment, the vehicular entertainment system is provided with a graphical user interface. Via this interface, a user can indicate that user-requestable content is not to be rendered or is always to be rendered without explicit input from the user. In this case, the user input described with respect to block 440 can be derived from prior action by the user. In other embodiments, the user can indicate that only specific user-requestable content is to be rendered, e.g. user-requestable content related to a particular sports team or any navigational data. These preferences can be stored, for example, in the storage 222 of FIG. 2.

Although block 420 is shown and described prior to blocks 430 and 440, in some embodiments, the user-requestable content is received later in the method 400. For example, in one embodiment, the user-requestable content is not received until after receiving the user input indicating that the user-requestable content is to be rendered. In this way, the system avoids using bandwidth for data which will not be rendered. In another embodiment, the reception of audiovisual data in block 410 and the reception of user-requestable content in block 420 are performed concurrently. For example, the system can receive a data file or a data stream comprising an audiovisual component and associated user-requestable content.

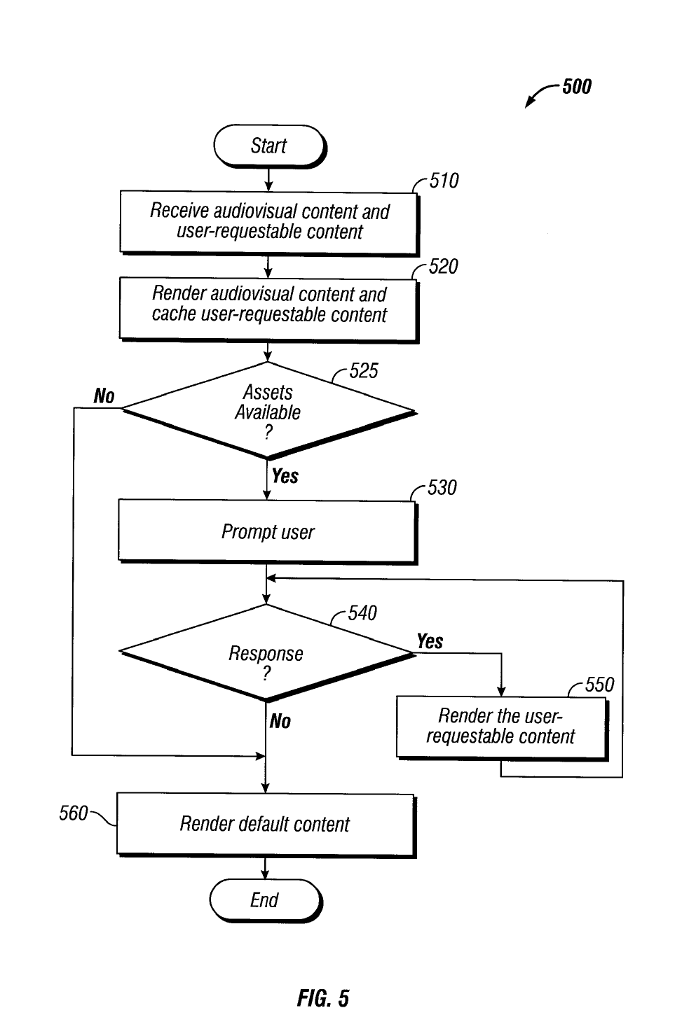

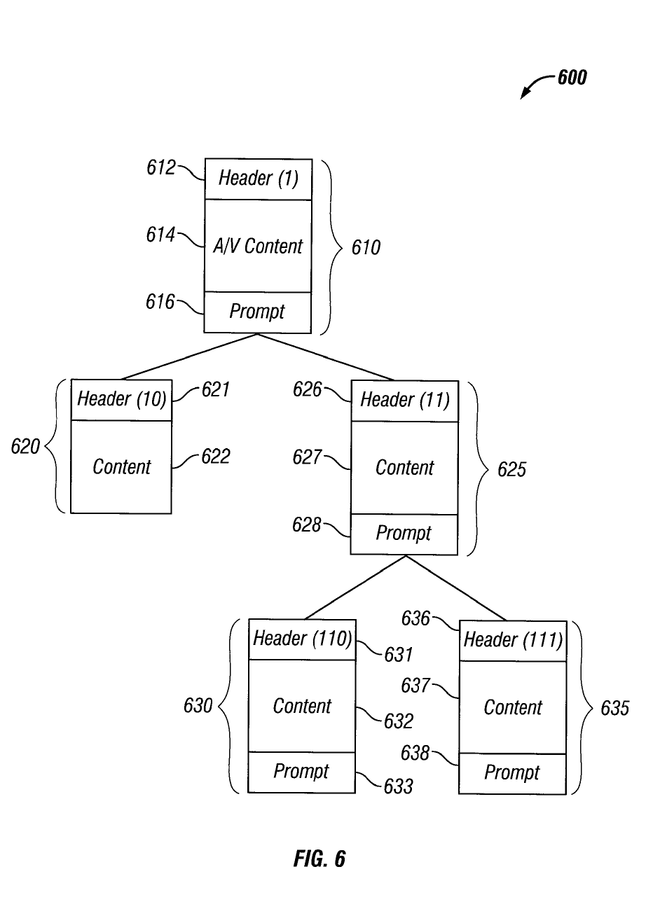

FIG. 5 is a flowchart illustrating a method of providing interactive content based on a voice prompt. The method 500 begins, in block 510, with the system, such as the vehicle 100 of FIG. 1 or the VES 210 of FIG. 2, receiving audiovisual content and user-requestable content. As described with respect to blocks 410 and 420, other embodiments separate the reception of audiovisual content and user-requestable content. As an example of receiving audiovisual content, the VES processor 110 of FIG. 1 can receive an AM broadcast via the antenna 112. The audiovisual content can include audio data, video data, or both. The audiovisual data and user-requestable content can be received in the form of a particular data structure. The data structure can be list, a graph, or a tree, as described with respect to FIG. 6 below.

Next, in block 520, the system renders the audiovisual content and caches the user-requestable content. For example, the system can play audio content via the speakers 242 of FIG. 2. As another example, the system can display video content on the display 240 of FIG. 2. The user-requestable content, the illustrated embodiment, is not automatically rendered. However, in some embodiments, the user-requestable content is rendered based on preferences set by the user. As the user-requestable content is not automatically rendered, it is stored until the user requests it. The user-requestable content can be stored in the storage 222 of FIG. 2.

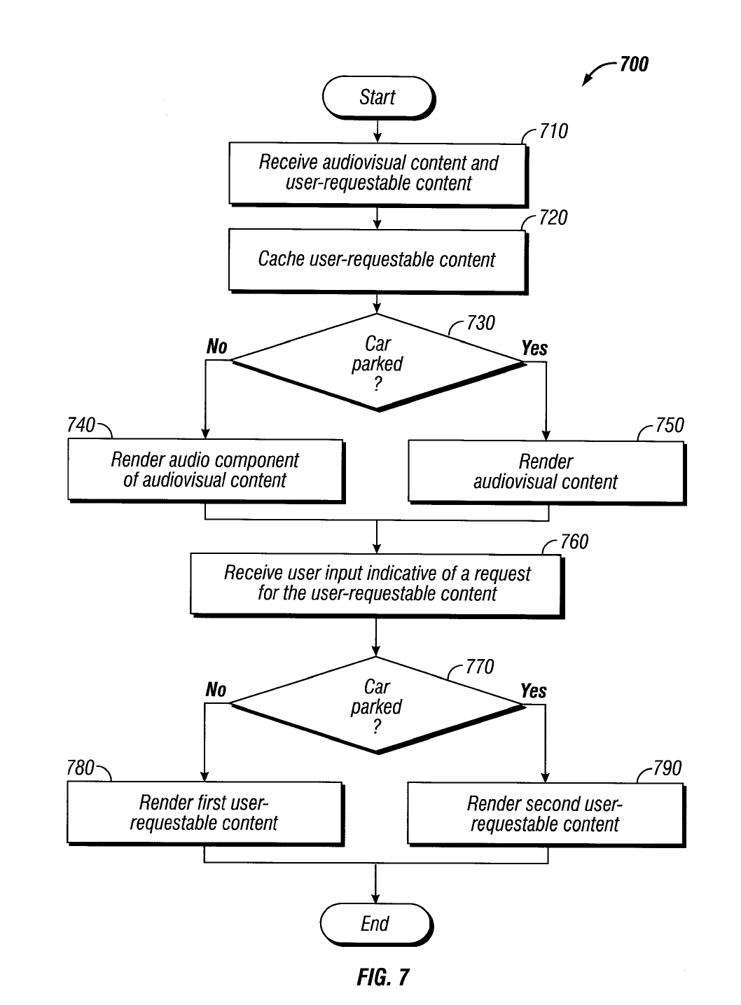

The process continues in block 525 with a determination of whether interactive assets are available. For example, a user of the system may be engaged in a hands-free telephone call using the available microphone and the system may thus be unable to receive a voice response from the user via the microphone. Alternatively, the system may be configured to not play interactive content when the user is engaged in a telephone call, or when the vehicle is in motion, as described in detail below with respect to FIG. 7. If the interactive assets are available, the process continues to block 530. If the interactive assets are unavailable the process skips to block 560 in which default, possibly non-interactive content is rendered.

Continuing to block 530, the system prompts the user with a voice prompt. The prompt can be portion of the audiovisual content. For example, the prompt can be a spokesperson saying “Would you like to hear more?” The prompt can also be displayed. For example, the prompt can be shown on a display stating, “Say ‘please’ for more information.”

Next, in block 540, the system determines if a response is received, if the response indicated a request for user-requestable content, or the nature of the response. This determination can be performed by the processor 220 of FIG. 2 in response to a waveform recorded by an input 230. In some embodiments, the input 230 comprises a microphone (possibly coupled to audio processing software or speech recognition software to, e.g., detect voice commands). The speech recognition software can be configured to recognize multiple commands in a single phrase to maximize the user experience. The processor 220 can also receive the input via the CAN bus 250 from a vehicular voice command module. In other embodiments, the prompt is shown on a touch screen display stating “Touch here for more information.” The prompt can include causing a button on a remote control to flash, whereupon pressing the flashing button results in user-requestable content being rendered.

As described above, the system determines if a response is received, if the response indicated a request for user-requestable content, or the nature of the response. In one embodiment, the system simply determines if a response is received. In the case of a voice response, an analysis of the intensity of a recorded waveform can indicate that the user responded. This can be used by the system as an indication of a response for which user-requestable content should be rendered. As described above, pressing a flashing button can result in a determination that a response has been received and that user-requestable content is to be rendered.

Such embodiments may have disadvantages, in that a user responding “No thanks” to a prompt of “Would you like to hear more” may nevertheless be provided with user-requestable content. In another embodiments, the system determines if the response indicated a request for user-requestable content. For example, the response may be processed by speech recognition software to determine if the response was positive or negative. As an example, an advertisement for a new iced coffee beverage may begin with audiovisual content indicating the deliciousness or inexpensiveness of the product. The audiovisual content can also include a prompt of “Can I show you where to get one of these tasty treats?” In response to an affirmation from the user, user-requestable content indicative of directions to a nearby restaurant can be submitted to the navigation system.

In another embodiment, the system determines the nature of the response. For example, the prompt may provide the user a choice between two sets of user-requestable content and the system determines which of the two choices the user response indicates. In another embodiment, the prompt may request the user to provide “secret” information in order to access the user-requestable content and the system determines if the “secret” information is correct. For example, at the end of a television broadcast of an episode of a television program, a content provider may provide that the “secret” word is “island.” A subsequent advertisement available later in the week may prompt “Say last week's ‘secret’ word in order to access an exclusive preview of next week's episode!” In response to a user answer, the system would determine if the nature of the response indicates that the additional content should be rendered.

In response to determining that user-requestable content should be rendered, the process moves to block 550 where the system renders the user-requestable content. The user-requestable content can include additional audiovisual content. Thus, rendering the user-requestable content can be performed as described above with respect to rendering the audiovisual content in block 430. The user-requestable content can, alternatively or additionally, include navigation data. Thus, rendering the user-requestable content can be performed by submitting commands to a navigation system to display a particular location or provide directions to a particular location. The user-requestable content can also include climate control data (or other environmental metadata). Thus, rendering the user-requestable content can be performed by submitting commands to a climate system to produce warm or cool air from vents. For example, an interactive advertisement can include audiovisual data including a prompt for “Is it hot in here?” In response, a user might say “yes” in which case the user-requestable content, comprising commands to the climate control system to produce cool air, would be rendered. The advertisement can continue with additional audiovisual content indicating “Y'know what else would cool you off? An iced coffee!”

The process can move from block 550 to block 560 or simply end the process. In block 560, also reached if the user does not indicate a response, or does not indicate that user-requestable content should be rendered, default content can, optionally, be rendered. The default content can also be audiovisual content. The default content can also be interactive content, resulting in multiple prompts for a particular advertisement.

In one embodiment, the audiovisual content and user-requestable content are received in the form of a particular data structure. The data structure can be list, a graph, or a tree. FIG. 6 is a diagram illustrating an exemplary data structure 600 for receiving or storing interactive content. The data structure 600 is arranged as a tree comprising a set of linked nodes. The base node 610 includes a header 612, audiovisual content 614, and a prompt 616. The header can contain data indicating that this is a base node, data indicative of the number of branches from the node, data indicative of the type of data in the node (A/V data), data indicative of the compression used for the A/V data, etc. The data indicating that this is a base node may be a node identifier. For the illustrated embodiment, the node identifier of the base node is (1). The audiovisual content 614, as described above, can contain audio data, video data, or both. The audiovisual content can be separable into an audio component and a video component. The prompt 616 can contain audiovisual data indicative of a prompt for a user. The prompt 616 can also contain data indicative of the branch (or node) to be accessed in response to particular user responses.

The base node 610 is associated with two branch nodes 620, 625. The first branch node 620 also includes a header 621 and content 622. The header, as described above, can contain data indicative of the node or nodes with which the branch is associated or the type of data in the node. The header 621 can also contain a node identifier, in this case (10). The content 622 can include user-requestable content or other content. The content can include audio content, visual content, climate control data, navigational data, etc. The second branch node 625 also includes a header 626 and content 627, but also includes a prompt 628. The prompt 628 indicates which of two other nodes 630, 635, each other node also including a header 631, 635 and content 632, 666, the system should access in response to a user request.

Other criteria can be used to alter or prevent the rendering of audiovisual content or user-requestable content. For example, there may be legal prescriptions against displaying video content to a driver while the vehicle is in motion. Embodiments can detect, for example via the CAN bus 250 of FIG. 2, that the vehicle is in motion and disable rendering of video to the front display. In other embodiments, video data is only rendered when the vehicle is in park. Thus, embodiments can determine whether the vehicle is in park prior to rendering any video or particular user-requestable content.

FIG. 7 is a flowchart illustrating a method of providing interactive content based on a vehicular state. The process 700 begins, in block 710, with the system receiving audiovisual content and user-requestable data. As described with respect to FIGS. 4 and 5, the system can be embodied by the vehicle 100 of FIG. 1 or the VES 210 of FIG. 2. As described with respect to block 510 of FIG. 5, the audiovisual content can include audio data, video data, or both and the user-requestable content can include additional audio data, video data, climate control data, navigation data, etc.

After receiving the user-requestable content in block 710, the process moves to block 720 where the user-requestable content is cached. As described with respect to block 520 of FIG. 5, as the user-requestable content is not automatically rendered, it is stored until the user requests it. The user-requestable content can be stored in the storage 222 of FIG. 2.

The system, in block 730, determines whether the vehicle is in a particular state. For example, the system can determine that the vehicle is in park based on information received over the CAN bus 250 of FIG. 2 from the transmission 264. As another example, the system can determine that the vehicle is below some threshold speed based on information received from the speedometer 266. Although block 730 is shown and described after block 710 and 720, the determination can be performed in advance of receiving and caching content.

If the vehicle is not in the first state, e.g. is not parked or is moving too quickly, the process 700 moves to block 740 where the audiovisual content is decomposed into an audio component and a video component and only the audio component is rendered. The audio component can be rendered via the speakers 242 of FIG. 2. In another embodiment, the audiovisual content contains alternative content, such as text, that can be displayed in lieu of the video component. If the vehicle is in the first state, e.g. parked, stopped, or moving slowly, the process moves to block 750 where the audiovisual content is rendered, including the video component.

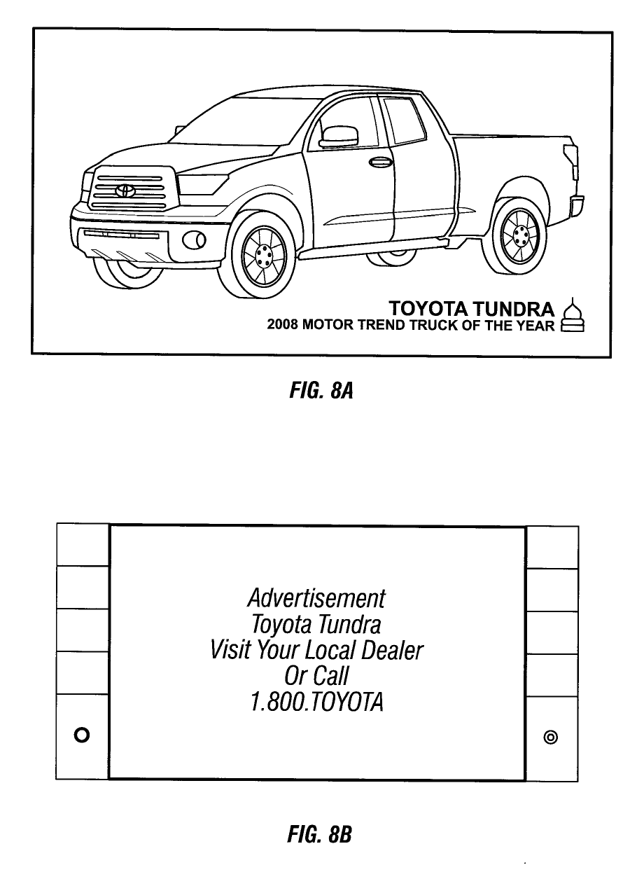

As shown in FIG. 1, a vehicle can have a front display 120 and a rear display 122. The front display 120 can be controlled by a touch screen and hard keys, whereas the rear display 122 can be controlled by a remote control. In yet another embodiment of the method 700 of FIG. 7, if the vehicle is not in the first state, the audiovisual content is still rendered in full on the rear display 122, however the video content is not displayed on front display 120. In another embodiment, the audiovisual content is rendered in full on the rear display 122 and alternative content is displayed on the front display 120. FIGS. 8A and 8B illustrate exemplary rendering of audiovisual content on a rear display (FIG. 8A) and a front display (FIG. 8B). In FIG. 8A, full motion video is rendered on the rear display 122. Conversely, in FIG. 8B, text is rendered on the front display 120. The text rendered on the front display 120 can change throughout the audiovisual content.

As described above, the alternative content can include text. For example, an advertiser can display a text version of their commercial. As another example, the text can include channel or program information if the audiovisual content is a television or mobile TV broadcast. In another embodiment, the alternative content includes a static (or quasi-static) image. A quasi-static image is one that changes less rapidly than video rates. For example, a quasi-static image may change every couple of minutes, or every thirty seconds. In another embodiment, the alternative content includes alternative video content. For example, if the audiovisual content is a music video, the audio content is rendered over the speakers, the video content is rendered on the rear display 122, and a music visualization is rendering on the front display 120.

In another embodiment, the alternative content is video content of the same nature as the original video content. For example, the audiovisual content can include a first audiovisual content portion to be rendered if the vehicle is in the first state and a second audiovisual content portion to be rendered if the vehicle is in the second state.

Proceeding from either block 740 or 750, the system receives user input indicative of a request for the user-requestable content. As described with respect to block 440 of FIG. 4, the user input can be receive from the input 230 of FIG. 2, via a touch screen display 240, or via an input external to the VES 210 such as a voice control system of the vehicle. The user input can include pressing a key on a remote control, touching a region of a touch screen display, or saying “yes” to a particular prompt asking if the user would like to request additional content.

In response to receiving the user input, the method 700 moves to block 770 where it is determined, again, whether the vehicle is in a particular state. The determination can be based on the previous determination in block 730 or redone just prior to rendering the user-requestable content. If it is determined that the vehicle is not in the first state, the method 700 moves to block 780 where first user-requestable content is rendered, whereas if it is determined that the vehicle is in the first state, the method 700 moves to block 790 where second user-requestable content is rendered.

The first and second user-requestable content can differ in that the first user-requestable content does not contain a video component, whereas the second user-requestable content contains a video component. The first and second user-requestable content may only differ in this respect, or they may differ in other respects as well. For example, with respect to the iced coffee advertisement described above, the second user-requestable content, rendered when the vehicle is parked, can contain instructions for the navigation system to display the locations of a number of nearby restaurant, whereas the first user-requestable content, rendered when the vehicle is in motion, can contain instructions for the navigation system to provide directions to the nearest restaurant.

While the above detailed description has shown, described, and pointed out novel features of the invention as applied to various aspects, it will be understood that various omissions, substitutions, and changes in the form and details of the device or process illustrated may be made by those skilled in the art without departing from the scope of this disclosure. As will be recognized, the invention may be embodied within a form that does not provide all of the features and benefits set forth herein, as some features may be used or practiced separately from others. The scope of this disclosure is defined by the appended claims, the foregoing description, or both. All changes which come within the meaning and range of equivalency of the claims are to be embraced within their scope.

What is claimed is:

1. A method of providing interactive content to a user, the method comprising:
receiving, in a vehicle via a wireless broadcast, audiovisual content and user-requestable content;
rendering the audiovisual content;
receiving user input indicative of request for the user-requestable content; and
rendering, in response to receiving the user input, the user-requestable content.

2. The method of claim 1, wherein the user-requestable content comprises additional audiovisual content.

3. The method of claim 2, wherein rendering comprises rendering the user-requestable content with a vehicular entertainment system of the vehicle.

4. The method of claim 1, wherein the user-requestable content is indicative of a location.

5. The method of claim 4, wherein rendering comprises rendering the user-requestable content with a navigation system of the vehicle.

6. The method of claim 1, wherein the user input is received via a vehicular voice command system.

7. The method of claim 1, further comprising, prior to rendering the user-requestable content, storing the user-requestable content in a memory device and retrieving the user-requestable content from the memory device.

8. The method of claim 1, further comprising determining whether the vehicle is in a first state, wherein rendering the audiovisual content is based on the determination.

9. The method of claim 8, wherein the first state is a park state.

10. The method of claim 8, wherein determining whether the vehicle is in a first state comprises determining the speed of the vehicle.

11. The method of claim 8, wherein the audiovisual content comprises audio content and video content, and wherein, if it determined that the vehicle is in the first state, rendering the audiovisual content comprises rendering only the audio content.

12. A system for providing interactive content to a user, the system comprising:
a receiver configured to receive, via a wireless broadcast, audiovisual content and user-requestable content;
an input device configured to receive a user input indicative of request for the user-requestable content; and
a vehicular entertainment system configured to render the audiovisual content and to render, in response to receiving the user input, the user-requestable content.

13. The system of claim 12, wherein the vehicular entertainment system comprises at least one of a processor configured to process or a storage configured to store at least one of the audiovisual content or the user-requestable content.

14. The system of claim 12, wherein the vehicular entertainment system comprises at least one of a display or a speaker upon which the audiovisual content is rendered.

15. The system of claim 12, wherein the vehicular entertainment system is further configured to receive an indication of a state of a vehicle.

16. The method of claim 15, wherein the audiovisual content comprises audio content and video content, and wherein, if it determined that the vehicle is not in a first state, rendering the audiovisual content comprises rendering only the audio content.

17. A system for providing interactive content to a user, the system comprising:
means for receiving audiovisual content and user-requestable content;
means for rendering the audiovisual content;
means for receiving user input indicative of request for the user-requestable content; and
means for rendering, in response to receiving the user input, the user-requestable content.

18. The system of claim 17, wherein the means for receiving audiovisual content and user-requestable content comprises at least one of an antenna, a network interface, a computer-readable storage, or a processor; the means for rendering the audiovisual content comprises at least one of a display, a speaker, or a processor; the means for receiving user input comprises at least one of a voice command system, an input device of a vehicular entertainment system, a computer-readable storage, or a processor; or the means for rendering the user-requestable content comprises at least one of a display, a speaker, a climate control system, a navigation system, or a processor.

19. A method of providing audiovisual content to a user, the method comprising:
receiving, in a vehicle via a wireless broadcast, audiovisual content, the audiovisual content comprising a video component and an alternative component associated with the video component;
determining whether the vehicle is in a first state; and
rendering, if the vehicle is in the first state, the video component on a first display and not rendering the alternative component on the first display, or
rendering, if the vehicle is not in the first state, the alternative component on the first display and not rendering the video component on the first display.

20. The method of claim 1, further comprising, rendering, if the vehicle is not in the first state, the video component on a second display.

21. The method of claim 1, wherein the audiovisual component further comprises an audio component, further comprising rendering the audio component over one or more speakers.

22. The method of claim 1, wherein the alternative component comprises at least one of text, an image, or video.

23. The method of claim 1, wherein the first display comprises a display viewable by a driver of the vehicle.

24. The method of claim 1, wherein determining whether the vehicle is in a first state comprising at least one of determining a speed of the vehicle or determining a transmission mode.

25. A computer-readable storage medium having executable instructions encoded thereon, wherein execution of the instructions causes one or more processors to perform method of providing interactive content to a user, the method comprising:
receiving, in a vehicle via a wireless broadcast, audiovisual content and user-requestable content;
rendering the audiovisual content;
receiving user input indicative of request for the user-requestable content; and
rendering, in response to receiving the user input, the user-requestable content.
